(19) United States
(12) Patent Application Publication
(10) Pub. No.: US 2023/0382090 A1
(43) Pub. Date: Nov. 30, 2023

(54) GAS BARRIER FILM

(71) Applicant: TOPPAN INC., Tokyo (JP)

(72) Inventors: Ryosuke KOGA, Tokyo (JP); Junpei HAYASHI, Tokyo (JP); Tetsuo SATAKE, Tokyo (JP); Kenta OSAWA, Tokyo (JP)

(73) Assignee: TOPPAN INC., Tokyo (JP)

(21) Appl. No.: 18/230,552

(22) Filed: Aug. 4, 2023

Related U.S. Application Data
(63) Continuation of application No. PCT/JP2022/004705, filed on Feb. 7, 2022.

(30) Foreign Application Priority Data
Feb. 8, 2021 (JP) 2021-018373

(51) Int. Cl. B32B 27/08; B32B 7/12; B32B 27/30; B32B 27/32; B32B 27/16; B65D 65/40

(52) U.S. Cl. CPC B32B 27/08; B32B 7/12; B32B 27/306; B32B 27/32; B32B 27/16; B65D 65/40; B32B 2307/7242; B32B 2307/31; B32B 2307/748; B32B 2255/10; B32B 2255/20; B32B 2255/26; B32B 2255/28; B32B 2250/03; B32B 2250/246; B32B 2307/518; B32B 2250/242; B65D 2565/387

(57) ABSTRACT

A gas barrier film includes a substrate containing polypropylene or polyethylene as a main ingredient, the substrate having a first surface and a second surface opposite the first surface; and a gas barrier layer arranged to face the first surface of the substrate. The second surface of the substrate has a wetting tension of 21 mN/m or more.

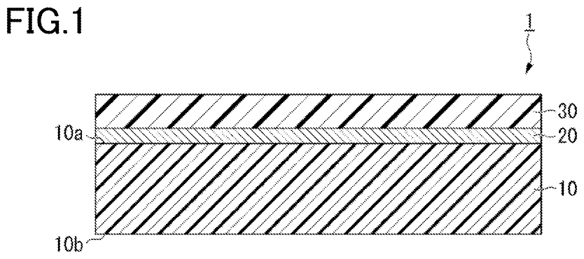

### CROSS-REFERENCE TO RELATED PATENT APPLICATIONS

This application is a continuation application filed under 35 U.S.C. § 111(a) claiming the benefit under 35 U.S.C. §§ 120 and 365(c) of International Patent Application No. PCT/JP2022/004705, filed on Feb. 7, 2022, which in turn claims the benefit of JP 2021-018373, filed Feb. 8, 2021, the disclosures of which are all incorporated herein by reference in its entirety.

### TECHNICAL FIELD

The present invention relates to gas barrier films.

### BACKGROUND

From the viewpoint of preventing the contents from being degraded and retaining the functions and properties of the contents, packaging materials used for packaging food products, non-food products, pharmaceuticals, and the like are required to have gas barrier properties for protecting the contents from oxygen, water vapor, and other gases passing through the packaging material and degrading the contents.

Known packaging materials having gas barrier properties include gas barrier films in which a metal foil such as of aluminum, which is less affected by temperature, humidity, and the like, is used as a gas barrier layer.

Another configuration of gas barrier films is known in which a vapor deposition film made of an inorganic oxide such as silicon oxide or aluminum oxide is formed by vacuum deposition, sputtering, or the like on the substrate film of a polymer material. These gas barrier films are transparent and have barrier properties against gases such as oxygen and water vapor.

When the gas barrier film is used as an intermediate layer of a multilayer laminate film, the surface not provided with a gas barrier layer is required to have adhesion to an adhesive or an ink layer. PTL 1 describes a gas barrier film in which the adhesion of this surface is improved.

### CITATION LIST

### Patent Literature

[PTL 1] WO 2019/087960 A1.

### SUMMARY OF THE INVENTION

### Technical Problem

In recent years, there is an increasing demand for gas barrier films using a substrate film made of polypropylene (PP) or polyethylene (PE) from the viewpoint of reducing the environmental impact. PTL 1 states that application of plasma treatment to the substrate can improve its adhesion to a vapor deposition layer.

However, PTL 1 does not contain a description of a PP or PE film.

In view of the above circumstances, an object of the present invention is to provide a gas barrier film that has high adhesion between the substrate and an adhesive or another layer, such as an ink layer, and achieves reduced environmental impact.

### Solution to Problem

A gas barrier film according to an aspect of the present invention includes a substrate containing polypropylene or polyethylene as a main ingredient, the substrate having a first surface and a second surface opposite the first surface; and a gas barrier layer arranged to face the first surface of the substrate.

The second surface of the substrate has a wetting tension of 21 mN/m or more.

### Advantageous Effect of the Invention

The gas barrier film of the present invention has high adhesion between the substrate and an adhesive or another layer, such as an ink layer, and achieves suppressed environmental impact.

### BRIEF DESCRIPTION OF THE DRAWINGS

The FIGURE is a schematic cross-sectional view of a gas barrier film according to an embodiment of the present invention.

### DETAILED DESCRIPTION

With reference to the Figure, an embodiment of the present invention will be described below.

The FIGURE is a schematic cross-sectional view of a gas barrier film 1 according to the present embodiment. The gas barrier film 1 includes a substrate 10, a gas barrier layer 20 formed on a first surface 10a of the substrate 10, a cover layer 30 covering the gas barrier layer 20.)

The substrate 10 is a resin film containing polypropylene or polyethylene as a main ingredient.

The substrate 10 may be a non-stretched film or a stretched film. When a stretched film is used, the stretch ratio is not specifically limited.

The thickness of the substrate 10 is not specifically limited. The substrate 10 may be configured as a single layer film, or a multilayer film obtained by laminating films having different properties, according to, for example, the application of the packaging material. From a practical standpoint, in view of processability for forming the gas barrier layer 20, the cover layer and the like, the thickness of the substrate 10 is preferably 3 to 200 μm, and more preferably 6 to 50 μm.

When the substrate 10 is configured as a multilayer film including a first surface layer providing the first surface 10a and a second surface layer providing a second surface 10b opposite the first surface, the thickness of each surface layer may be several tens of nanometers to several μm and is selected as appropriate according to their functions. When polypropylene is used for the substrate 10, the composition of each surface layer may be a copolymer obtained by copolymerizing propylene with polyethylene such that the ratio of polyethylene to propylene is to several tens of percent. Examples of polyethylene include high-density polyethylene (HDPE), medium-density polyethylene (MDPE), low-density polyethylene (LDPE), and linear low-density polyethylene (LLDPE). Alternatively, the composition of each surface layer may be a multimer obtained by copolymerizing propylene or ethylene with, for example, an α-olefin-based resin such as 1-Butene and/or a rubber component such as an elastomer such that the ratio of the latter to the former is 0.1 to several tens of percent. Moreover, instead of copolymerization, the above resins may be mixed and dispersed in the respective components.

For better gas barrier properties, polyvinyl alcohol (PVA) or ethylene-vinyl alcohol copolymer (EVOH) may be used for the surface layer providing the first surface 10a.

When polyethylene is used for the substrate 10, the polyethylene resin may be one or more selected from HDPE, LDPE, MDPE, and LLDPE. The composition of each surface layer may be a multimer obtained by copolymerizing ethylene with, for example, an α-olefin resin such as 1-Butene and/or a rubber component such as an elastomer such that the ratio of the latter to the former is 0.1 to several tens of percent. Furthermore, PVA or EVOH may be used for the surface layer providing the first surface 10a.

When the substrate 10 is configured as a multilayer structure, it may be formed by coextrusion of materials using a plurality of screws to provide a film composed of a plurality of layers. Although the boundaries between the layers of the substrate 10 formed as described above cannot be clearly seen even under an optical microscope, they can be seen by appropriately staining the substrate 10 and observing the cross section thereof under a transmission electron microscope (TEM).

The substrate 10 may contain one or more additives other than resin components. These additives may be suitably selected from known various additives. Examples of additives include anti-blocking agents (AB agents), thermal stabilizers, weather resistance stabilizers, UV absorbers, lubricants, slip agents, nucleating agents, antistatic agents, anti-fog agents, pigments, and dyes. AB agents may be organic or inorganic. These additives may be used singly or in combination of two or more. Among the above examples of additives, lubricants and slip agents are preferable from the viewpoint of processability. The content of the one or more additives in the substrate 10 may be adjusted as appropriate within a range that does not hinder the advantageous effects of the present invention.

The second surface 10b of the substrate 10 has a wetting tension of 21 mN/m or more. The wetting tension can be calculated using the method for determining the wetting tension (JIS K 6788) or from a water contact angle.

The wetting tension of the second surface 10b can be adjusted, for example, by subjecting the second surface 10b to corona treatment, plasma treatment, ozone treatment, flame treatment, or the like, or by forming on the second surface 10b a coating layer containing a thermoplastic resin, a thermosetting resin, a UV-curable resin, or the like.

For plasma treatment, argon or oxygen can be used.

The gas barrier layer 20 is made of a silicon oxide, carbon-containing silicon oxide, silicon nitride, aluminum metal, or aluminum oxide, or contains one of these as a main ingredient. The gas barrier layer 20 exhibits barrier properties against some gases, such as oxygen and water vapor. The gas barrier layer 20 may be transparent or opaque.

The thickness of the gas barrier layer 20 varies depending on the type, composition, and film formation method of the component used, but in general can be set appropriately in a range of 3 to 300 nm. When the thickness of the gas barrier layer 20 is less than 3 nm, the film may not be uniform or may not have a sufficient thickness, and may fail to sufficiently exhibit functions as a gas barrier layer. When the thickness of the gas barrier layer 20 is more than 300 nm, external factors such as bending and tension after the film is formed may cause cracking in the gas barrier layer 20, resulting in loss of barrier properties. Accordingly, the thickness of the gas barrier layer 20 is preferably 6 to 150 nm.

The formation method for the gas barrier layer 20 is not limited, and may be, for example, vacuum deposition, plasma-activated deposition, sputtering, ion plating, ion beam deposition, plasma-enhanced chemical vapor deposition (CVD), and the like can be used. A plasma-assisted method, an ion beam-assisted method, and the like can be combined to form a gas barrier layer 20 with high density to thereby enhance barrier properties and adhesiveness.

The cover layer 30 protects the gas barrier layer 20 and further enhances the barrier properties of the gas barrier layer 1. The cover layer 30 may be a coating layer made of one or more selected from a thermoplastic resin, a thermosetting resin, a UV-curable resin, a metal alkoxide, a water-soluble polymer, a polycarboxylic acid-based polymer, a polyvalent metal compound, a polyvalent-metal salt of a carboxylic acid as a reaction product of a polycarboxylic acid-based polymer and a polyvalent metal compound, and the like. In particular, a metal alkoxide and a water-soluble polymer, which have good oxygen barrier properties, are preferable. A cover layer 30 made of these components is formed using a coating material having a main component composed of an aqueous solution or a water/alcohol mixed solution containing one or more metal alkoxides or hydrolysates thereof and a water-soluble polymer. For example, the coating material may be prepared by dissolving a water-soluble polymer in an aqueous (water or water/alcohol mixture) solvent, and mixing into the resulting solution a metal alkoxide or a product obtained by subjecting the metal alkoxide to hydrolysis or other process. This coating material is then applied to the gas barrier layer 20 and dried to form the cover layer 30.

The components contained in the coating material for forming the cover layer 30 will be described in greater detail. Examples of the water-soluble polymer used for the coating material may include polyvinyl alcohol (PVA), polyvinyl pyrrolidone, starch, methyl cellulose, carboxymethyl cellulose, and sodium alginate. In particular, PVA is preferable because it can be used to provide good gas barrier properties. PVA is typically obtained by saponifying polyvinyl acetate. The PVA may be either a partially saponified PVA, in which several tens % of acetic acid groups remain, or a fully saponified PVA, in which only several % of acetyl groups remain. A PVA intermediate between these PVAs may also be used.

The metal alkoxide used for the coating material is a compound represented by the general formula M(OR)n (where M is a metal such as Si or Al, and R is an alkyl group such as CH₃ or C₂H₅). Specifically, tetraethoxysilane [Si(OC₂H₅)₄], triisopropoxy aluminum Al[OCH(CH₃)₂]₃, or the like may be used. Examples of silane coupling agents include those having an epoxy group such as 3-glycidoxypropyltrimethoxysilane, those having an amino group such as 3-aminopropyltrimethoxysilane, those having a mercapto group such as 3-mercaptopropyltrimethoxysilane, those having an isocyanate group such as 3-isocyanato propyltriethoxysilane, and tri s-(3-trimethoxysilylpropyl) isocyanurate.

The polycarboxylic acid-based polymer refers to a polymer having two or more carboxyl groups in a molecule.

Examples of the polycarboxylic acid-based polymer include an ethylenically unsaturated carboxylic acid (co)polymer; a copolymer of ethylenically unsaturated carboxylic acid and another ethylenically unsaturated monomer; and alginic acid, carboxymethyl cellulose, and acidic polysaccharides having a carboxyl group in a molecule such as pectin.

The ethylenically unsaturated carboxylic acid may be, for example, acrylic acid, methacrylic acid, itaconic acid, maleic acid, fumaric acid, or crotonic acid.

Examples of the ethylenically unsaturated monomer copolymerizable with the ethylenically unsaturated carboxylic acid include ethylene, propylene, saturated carboxylic acid vinyl esters such as vinyl acetate, alkyl acrylates, alkyl methacrylates, alkyl itaconates, vinyl chloride, vinylidene chloride, styrene, acrylamide, and acrylonitrile.

These polycarboxylic acid polymers may be used alone or as a mixture of two or more.

Of the above components, from the viewpoint of gas barrier properties, a polymer containing a constituent unit derived from at least one polymerizable monomer selected from the group consisting of acrylic acid, maleic acid, methacrylic acid, itaconic acid, fumaric acid, and crotonic acid is preferable; and a polymer containing a constituent unit derived from at least one polymerizable monomer selected from the group consisting of acrylic acid, maleic acid, methacrylic acid, and itaconic acid is particularly preferable.

In the above polymer, a ratio of the constituent unit derived from at least one polymerizable monomer selected from the group consisting of acrylic acid, maleic acid, methacrylic acid, and itaconic acid is preferably 80 mol % or more, and more preferably 90 mol % or more (where the total volume of all the constituent units constituting the polymer is 100 mol %). This polymer may be a homopolymer or a copolymer. When the polymer is a copolymer containing an additional constituent unit other than the above constituent units, the additional constituent unit may be, for example, a constituent unit derived from the above-described ethylenically unsaturated monomer copolymerizable with the ethylenically unsaturated carboxylic acid.

The polycarboxylic acid-based polymer preferably has a number average molecular weight in the range of 2,000 to 10,000,000, and more preferably in the range of 5,000 to 1,000,000. If the polycarboxylic acid-based polymer has a number average molecular weight of less than 2,000, a gas barrier film cannot achieve sufficient water resistance depending on the use, and moisture may cause deterioration of gas barrier properties and transparency or may cause occurrence of blushing. If the polycarboxylic acid-based polymer has a number average molecular weight of more than 10,000,000, a coating material may have low coatability due to high viscosity.

In the present invention, the number average molecular weight is obtained by gel permeation chromatography (GPC) in terms of polystyrene.

Various additives may be added to a coating material having a polycarboxylic acid-based polymer as a main component. Examples of these additives include cross-linking agent, curing agent, leveling agent, antifoaming agent, anti-blocking agent, antistatic agent, dispersant, surfactant, softening agent, stabilizer, film-forming agent, thickener, and the like within a range in which barrier properties are not impaired.

A solvent used for a coating material having a polycarboxylic acid-based polymer as a main component is preferably an aqueous medium. The aqueous medium may be water, a water-soluble or hydrophilic organic solvent, or a mixture thereof. The aqueous medium is typically water or a medium that contains water as a main component. The content of water in the aqueous medium is preferably 70 mass % or more, and more preferably 80 mass % or more.

Examples of the water-soluble or hydrophilic organic solvent include alcohols such as methanol, ethanol, and isopropanol; ketones such as acetone and methyl ethyl ketone; ethers such as tetrahydrofuran; cellosolves; carbitols; and nitriles such as acetonitrile.

The polyvalent metal compound is not particularly limited as long as it reacts with a carboxyl group of a polycarboxylic acid-based polymer to form a polyvalent-metal salt of a polycarboxylic acid. Examples of such a polyvalent metal compound include zinc oxide particles, magnesium oxide particles, magnesium methoxide, copper oxide, and calcium carbonate. These compounds may be used alone or as a mixture of two or more. Among the above compounds, zinc oxide is preferable from the viewpoint of oxygen barrier properties of an oxygen barrier film. Zinc oxide is an inorganic material having the ability to absorb ultraviolet light. Although the average particle size of zinc oxide particles is not particularly limited, from the viewpoint of gas barrier properties, transparency, and coating suitability, it is preferably 5 μm or less, more preferably 1 μm or less, and particularly preferably 0.1 μm or less.

When a film is formed by applying a coating material having a polyvalent metal compound as a main component and drying the applied coating material, the coating material may contain various additives in addition to the zinc oxide particles if necessary to such an extent that the advantageous effects of the present invention are not impaired. Examples of the additives include resins soluble or dispersible in a solvent used for the coating material, and dispersants, surfactants, softening agents, stabilizers, film-forming agents, and thickeners that are soluble or dispersible in the solvent.

Of these additives, the coating material preferably contains a resin that is soluble or dispersible in the solvent used for the coating material. This improves the coatability and film formability of the coating material. Examples of such a resin include an alkyd resin, a melamine resin, an acrylic resin, a urethane resin, a polyester resin, a phenol resin, an amino resin, a fluoropolymer, an epoxy resin, and an isocyanate resin.

Furthermore, the coating material preferably contains a dispersant that is soluble or dispersible in the solvent used for the coating material. This improves the dispersibility of the polyvalent metal compound. The dispersant may be an anionic surfactant or a nonionic surfactant. Examples of the surfactant include various surfactants such as (poly)carboxylic acid salts, alkyl sulfate ester salts, alkylbenzene sulfonic acid salts, alkylnaphthalene sulfonic acid salt, alkylsulfosuccinic acid salts, alkyl diphenyl ether disulfonic acid salts, alkyl phosphate salts, aromatic phosphate esters, polyoxyethylene alkyl ethers, polyoxyethylene alkyl phenol ethers, polyoxyethylene alkyl esters, alkylaryl sulfate ester salts, polyoxyethylene alkyl phosphate esters, sorbitan alkyl esters, glycerol fatty acid esters, sorbitan fatty acid esters, sucrose fatty acid esters, polyethylene glycol fatty acid esters, polyoxyethylene sorbitan alkyl esters, polyoxyethylene alkylaryl ethers, polyoxyethylene derivatives, polyoxyethylene sorbitol fatty acid esters, polyoxy fatty acid esters, and polyoxyethylene alkylamines. These surfactants may be used alone or as a mixture of two or more.

When the coating material having a polyvalent metal compound as a main component contains one or more additives, the mass ratio of the polyvalent metal compound to the one or more additives (polyvalent metal compound:one or more additives) is preferably in the range of 30:70 to 99:1, and preferably in the range of 50:50 to 98:2.

Examples of the solvent used for the coating material having a polyvalent metal compound as a main component include water, methyl alcohol, ethyl alcohol, isopropyl alcohol, n-propyl alcohol, n-butyl alcohol, n-pentyl alcohol, dimethyl sulfoxide, dimethylformamide, dimethylacetamide, toluene, hexane, heptane, cyclohexane, acetone, methyl ethyl ketone, diethyl ether, dioxane, tetrahydrofuran, ethyl acetate, and butyl acetate. These solvents may be used alone or as a mixture of two or more.

Of these solvents, from the viewpoint of coatability, the solvent is preferably methyl alcohol, ethyl alcohol, isopropyl alcohol, toluene, ethyl acetate, methyl ethyl ketone, or water. From the viewpoint of manufacturability, the solvent is preferably methyl alcohol, ethyl alcohol, isopropyl alcohol, or water.

When a film of a polyvalent metal compound is formed after a film is formed by applying a coating material having a polycarboxylic acid-based polymer as a main component and drying the applied coating material, part of the carboxyl group in the polycarboxylic acid-based polymer may be neutralized in advance with a basic compound. Neutralizing part of the carboxyl group in the polycarboxylic acid-based polymer in advance further improves water resistance and heat resistance of the film made of the polycarboxylic acid-based polymer.

Preferably, the basic compound is at least one selected from the group consisting of the above polyvalent metal compounds, monovalent metal compounds, and ammonia. Examples of monovalent metal compounds include sodium hydroxide and potassium hydroxide.

When a film is formed by applying a coating material containing a mixture of a polycarboxylic acid-based polymer and a polyvalent metal compound and drying the applied coating material, the coating material is prepared by mixing the polycarboxylic acid-based polymer, the polyvalent metal compound, a resin or dispersant soluble or dispersible in water or alcohol as a solvent, and, if necessary, one or more other additives soluble or dispersible in the solvent. The cover layer 30 can be formed by applying and drying such a coating material using a known coating method.

Examples of a coating method for the cover layer 30 include casting, dipping, roll coating, gravure coating, screen printing, reverse coating, spray coating, kit coating, die coating, metering bar coating, combined chamber and doctor coating, and curtain coating.

The thickness of the cover layer 30 varies depending on the composition, coating conditions, and the like of the coating material used, and is not specifically limited. However, when the dry thickness of the cover layer 30 is 0.01 μm or less, the film may not be uniform, resulting in a failure in obtaining sufficient gas barrier properties. When the dry thickness of the cover layer 30 is more than 50 μm, cracking may easily occur in the cover layer 30. Therefore, a preferable thickness of the cover layer 30 may be, for example, 0.01 to 50 μm. Further, the cover layer 30 is preferred to have a thickness of, for example, 0.1 to 10 μm.

The gas barrier film 1 of the present embodiment having the above configuration exhibits good gas barrier properties and contains polyethylene or polypropylene as a main resin component. The content of the main resin component in the gas barrier film 1 can be easily set to mass % or more. That is, the gas barrier film 1 can be configured as a mono-material having high recyclability.

When a packaging material such as for a packaging bag is produced using the gas barrier film 1, further providing a heat-sealable layer on the second surface 10b allows a packaging material to be easily produced by heat sealing portions of the heat-sealable layer. In this case also, using the same main resin component for the heat-sealable layer and the substrate 10 provides a packaging material as a mono-material.

The heat-sealable layer may be made of polypropylene or polyethylene, and may be composed of one or more layers. The multilayer resin film discussed in the description of the substrate 10 may be used as the heat-sealable layer.

The thickness of the heat-sealable layer is selected depending on the purpose, and may be, for example, 15 to 200 μm. The heat-sealable layer may be provided by laminating a resin film through dry lamination using an adhesive, or by extrusion lamination using a resin in a fluid state.

The resin component in the substrate of the present embodiment has low polarity, and thus a heat-sealable layer is not easily bonded thereto by extrusion lamination or dry lamination. However, the substrate 10 according to the present embodiment has significantly improved bonding to the heat-sealable layer since the second surface 10b has a wetting tension of 21 mN/m or more. With dry lamination in particular, an adhesive evenly spreads over the second surface 10b since its wetting tension is 21 mN/m or more, so that a resin film serving as a heat-sealable layer is bonded to the substrate 10 with high adhesion.

From the viewpoint of appropriately providing a heat-sealable layer on the second surface 10b, although there is no upper limit on the value of the wetting tension of the second surface 10b, the present inventors found that setting the value of the wetting tension to within a given range provides a further advantage.

When the gas barrier film 1 is distributed as it is, it may be distributed in roll form. When a purchaser of this gas barrier film 1 provides a heat-sealable layer on the gas barrier film 1, he or she provides the heat-sealable layer while unwinding the rolled gas barrier film 1.

In this operation, when the second surface 10b has an excessively high wetting tension, blocking easily occurs in which the second surface 10b adheres to the cover layer 30 and becomes difficult to separate therefrom, leading to a decrease in efficiency of the process of providing the heat-sealable layer. Through the study conducted by the investors, it was found that setting the wetting tension of the second surface 10b to less than 50 mN/m appropriately suppresses blocking.

The gas barrier film according to the present embodiment will be further described using the examples and comparative examples. The present invention should not be limited in any way by the specifics of the examples and comparative examples.

As the substrate 10, a three-layer polypropylene film (total thickness: 20 μm) was used which had an EVOH layer (thickness: 1 μm) as a layer providing the first surface, a copolymer layer (thickness: 1 μm) made of a copolymer of propylene and ethylene as a layer providing the second surface, and a propylene homopolymer layer (thickness: 18 μm) therebetween.

In a vacuum device, SiO was sublimated, and a gas barrier layer 20 (thickness: 30 nm) made of a silicon oxide (SiOx) was formed on the first surface of the substrate 10 by electron beam evaporation. While maintaining the vacuum state, the second surface of the substrate was subjected to plasma treatment using Ar gas at a plasma treatment intensity of 30 W·sec/m². The plasma treatment intensity was calculated by the following expression.

Plasma treatment intensity=input power·processing time/cathode area

The wetting tension of the second surface after plasma treatment was 25 mN/m, as measured according to JIS K 6768.

Subsequently, a coating material obtained by mixing the following solutions A and B at a mass ratio of 6:4 was applied to the gas barrier layer 20 by gravure coating, and dried to form a cover layer 30 having a thickness of 0.4 μm.

Solution A: Hydrolyzed solution having a solid content of 3 wt % (in terms of SiO₂) obtained by adding 89.6 g of hydrochloric acid (0.1 N) to 10.4 g of tetraethoxysilane, and stirring the mixture for 30 minutes for hydrolysis

Solution B: 3 wt % water of polyvinyl alcohol/isopropyl alcohol solution (mass ratio of water:isopropyl alcohol=90:10)

Thus, the gas barrier film according to Example 1 was formed.

### Example 2

A gas barrier film of Example 2 was produced in the same manner as in Example 1, except that a plasma treatment intensity was changed to 67 W·sec/m². The wetting tension of the second surface after plasma treatment was 31 mN/m.

### Example 3

A gas barrier film of Example 3 was produced in the same manner as in Example 1, except that a plasma treatment intensity was changed to 83 W·sec/m². The wetting tension of the second surface after plasma treatment was 32 mN/m.

### Example 4

A gas barrier film of Example 4 was produced in the same manner as in Example 1, except that a plasma treatment intensity was changed to 300 W·sec/m². The wetting tension of the second surface after plasma treatment was 33 mN/m.

### Example 5

A gas barrier film of Example 5 was produced in the same manner as in Example 1, except that a plasma treatment intensity was changed to 500 W·sec/m². The wetting tension of the second surface after plasma treatment was 34 mN/m.

### Example 6

A gas barrier film of Example 6 was produced in the same manner as in Example 1, except that a plasma treatment intensity was changed to 600 W·sec/m². The wetting tension of the second surface after plasma treatment was 37 mN/m.

### Example 7

A gas barrier film of Example 7 was produced in the same manner as in Example 1, except that plasma treatment was performed at a plasma treatment intensity of 300 W·sec/m² using 02 gas. The wetting tension of the second surface after plasma treatment was 50 mN/m.

### Example 8

A gas barrier film of Example 8 was produced in the same manner as in Example 1, except that plasma treatment was performed at a plasma treatment intensity of 300 W·sec/m² using N₂ gas. The wetting tension of the second surface after plasma treatment was 50 mN/m.

### Example 9

A gas barrier film of Example 9 was produced in the same manner as in Example 1, except that aluminum was evaporated in the vacuum device while introducing oxygen thereinto to form, on the first surface of the substrate 10, a gas barrier layer 20 (10 nm in thickness) composed of an aluminum oxide (AlOx) by electron beam evaporation. The wetting tension of the second surface after plasma treatment was 25 mN/m.

### Example 10

A gas barrier film of Example 10 was produced in the same manner as in Example 1, except that plasma treatment was performed at a plasma treatment intensity of 100 W·sec/m² using Ar gas, and that, as the substrate 10, a biaxially-oriented high-density polyethylene film (20 μm in total thickness) was used that had a three-layer structure including a high-density polyethylene layer (1 μm in thickness), a high-density polyethylene layer (1 μm in thickness) providing the second surface, and a high-density polyethylene layer (18 μm in thickness) therebetween. The wetting tension of the second surface after plasma treatment was 32 mN/m.

### Example 11

A gas barrier film of Example 11 was produced in the same manner as in Example 1, except that plasma treatment was performed at a plasma treatment intensity of 100 W·sec/m² using Ar gas, and that, as the substrate 10, a non-stretched high-density polyethylene film (20 μm in total thickness) was used that had a three-layer structure including a high-density polyethylene layer (1 μm in thickness), a high-density polyethylene layer (1 μm in thickness) providing the second surface, and a high-density polyethylene layer (18 μm in thickness) therebetween. The wetting tension of the second surface after plasma treatment was 34 mN/m.

### Example 12

A gas barrier film of Example 12 was produced in the same manner as in Example 11, except that plasma treatment was performed at a plasma treatment intensity of 300 W·sec/m² using 02 gas. The wetting tension of the second surface after plasma treatment was 59 mN/m.

### Comparative Example 1

A gas barrier film of Comparative Example 1 was produced in the same manner as in Example 1, except that plasma treatment was not applied to the second surface of the substrate. The wetting tension of the second surface was 20 mN/m.

### Comparative Example 2

A gas barrier film of Comparative Example 2 was produced in the same manner as in Example 9, except that plasma treatment was not applied to the second surface of the substrate. The wetting tension of the second surface was 20 mN/m.

The following evaluations were performed on the gas barrier films of the respective examples.

(Evaluation 1: Adhesion of Heat-Sealable Layer)

A heat-sealable layer was provided on each second surface of the gas barrier films according to the respective examples by laminating a stretched polypropylene film having a thickness of 20 μm on each second surface through dry lamination using a two-part curing type polyurethane-based adhesive.

Test pieces were cut from each gas barrier film of the respective examples provided with the heat-sealable layer according to JIS K 6854-2 or JIS K 6854-3, and a peel strength between the substrate and the heat-sealable layer was measured using a TENSILON universal testing machine RTC-1250 manufactured by Orientec Corporation.

In the measurement, two types of peeling, T-peel and 180-degree peel, were performed.

(Evaluation 2: Blocking Between Substrate and Cover Layer)

Two samples having a square shape with a side length of 70 mm were cut from the gas barrier film of each example not provided with a heat-sealable layer, and were overlaid on each other. The overlapped two samples were subjected to a pressure of 200 kg and stored at 50° C. for two days, using a blocking tester CO-201 manufactured by Tester Sangyo Co., Ltd.

Subsequently, a peel strength between the upper sample and the lower sample was measured using Autograph manufactured by Shimadzu Corporation according to JIS K 6854-2 or JIS K 6854-3. In the measurement, two types of peeling, T-peel and 180-degree peel, were performed.

The results are shown in Table 1.

TABLE 1

| | | | Treatment | Wetting | Peel strength (N/15 mm) | | | |
|---|---|---|---|---|---|---|---|---|
| | Plasma | | intensity | tension | Evaluation 1 | | Evaluation 2 | |
| | treatment | Gas | (W · sec/m²) | (mN/m) | T-peel | 180° | T-peel | 180° |
| Ex. 1 | Performed | Ar | 30 | 25 | 3.9 | 4.9 | 0.01 | 0.01 |
| Ex. 2 | Performed | Ar | 67 | 31 | 3.8 | 4.8 | 0.01 | 0.01 |
| Ex. 3 | Performed | Ar | 83 | 32 | 3.9 | 5.1 | 0.02 | 0.02 |
| Ex. 4 | Performed | Ar | 300 | 33 | 4.5 | 5.0 | 0.01 | 0.02 |
| Ex. 5 | Performed | Ar | 500 | 34 | 3.4 | 4.8 | 0.01 | 0.02 |
| Ex. 6 | Performed | Ar | 600 | 37 | 3.8 | 4.8 | 0.01 | 0.02 |
| Ex. 7 | Performed | O₂ | 300 | 50 | 4.6 | 4.6 | 0.12 | 0.06 |
| Ex. 8 | Performed | N₂ | 300 | 50 | 4.5 | 4.8 | 0.10 | 0.06 |
| Ex. 9 | Performed | Ar | 30 | 25 | 3.8 | 4.8 | 0.01 | 0.01 |
| Ex. 10 | Performed | Ar | 100 | 32 | 1.2 | 0.5 | 0.01 | 0.01 |
| Ex. 11 | Performed | Ar | 100 | 34 | 9.8 | 9.9 | 0.01 | 0.01 |
| Ex. 12 | Performed | O₂ | 300 | 59 | 11.0 | 12.6 | 0.01 | 0.01 |
| Comp. | Not performed | — | — | 20 | 0.1 | 0.1 | 0.01 | 0.01 |
| Ex. 1 | | | | | | | | |
| Comp. | Not performed | — | — | 20 | 0.1 | 0.1 | 0.01 | 0.01 |
| Ex. 2 | | | | | | | | |

In all the Examples, the peel strength in Evaluation 1 was 1 N/15 mm or more for at least one of T-peel and 180-degree peel, and thus it was found that the heat-sealable layer provided on the second surface of the peelable substrate was well adhered to the substrate.

Moreover, in Examples 1 to 6 where the wetting tension of the second surface was less than 50 mN/m, the peel strength in Evaluation 2 was less than 0.03 N/15 mm for both T-peel and 180-degree peel, and thus blocking was suppressed.

In Comparative Examples 1 and 2, although blocking did not occur, the peel strength in Evaluation 1 was low, and the adhesion between the substrate and the heat-sealable layer was insufficient.

While an embodiment and examples of the present invention have been described, the specific configurations are not limited to the above embodiment. Various modifications and combinations of the configurations can be made without departing from the spirit of the present invention.

For example, by providing another resin layer on the cover layer, the gas barrier film according to the above-described embodiment may be used as an intermediate layer of a multilayer film. The resin layer provided on the cover layer may be formed of the same material as the substrate 10.

In the gas barrier film of the present invention, the cover layer may not be necessary. When the cover layer is not provided, the gas barrier layer disposed on the first surface is exposed. However, when, for example, the gas barrier film is used as an intermediate layer, another resin layer provided on the gas barrier layer protects the gas barrier layer, and thus omission of the cover layer presents no problems.

### INDUSTRIAL APPLICABILITY

The gas barrier film of the present invention is suitable for packaging food products, pharmaceuticals, precision electronic components, and the like. The gas barrier film of the present invention has high adhesion between the substrate and an adhesive or another layer, such as an ink layer, and achieves suppressed environmental impact.

[Reference Signs List] 1 Gas barrier film; 10 Substrate; 10a First surface; 10b Second surface; 20 Gas barrier layer; 30 Cover layer.

What is claimed is:

1. A gas barrier film, comprising:
a substrate containing polypropylene or polyethylene as a main ingredient, the substrate having a first surface and a second surface opposite the first surface; and
a gas barrier layer arranged to face the first surface of the substrate,
the second surface of the substrate having a wetting tension of 21 mN/m or more.

2. The gas barrier film of claim 1, wherein:
the main ingredient of the substrate is polypropylene; and
the wetting tension of the second surface of the substrate is less than 50 mN/m.

3. The gas barrier film of claim 1, wherein:
the substrate includes an outermost layer portion providing the first surface; and
the layer portion of the substrate comprises a material selected from any one of polypropylene, polyethylene, a composite of propylene and ethylene, a composite of propylene, ethylene, and α-olefin, polyvinyl alcohol, and an ethylene-vinyl alcohol copolymer.

4. The gas barrier film of claim 1, further comprising:
a heat-sealable layer arranged to face the second surface of the substrate.

5. The gas barrier film of claim 4, wherein:
the heat-sealable layer contains a main ingredient; and
the main ingredient of the substrate is the same as the main ingredient of the heat-sealable layer.

6. The gas barrier film of claim 4, wherein:
the substrate and the heat-sealable layer are bonded to each other with an adhesive.

7. The gas barrier film of claim 4, wherein:
the substrate and the heat-sealable layer have a peel strength of 1 N/15 mm or more therebetween, as measured according to JIS K 6854-2 or JIS K 6854-3.

8. The gas barrier film of claim 1, wherein:
the gas barrier layer contains one of silicon oxide, carbon-containing silicon oxide, silicon nitride, and aluminum oxide.

9. The gas barrier film of claim 1, further comprising:
a cover layer arranged to face a surface of the gas barrier layer opposite to that facing the substrate,
the cover layer containing one of a metal alkoxide, a hydrolysate of a metal alkoxide, a water-soluble polymer, a polycarboxylic acid-based polymer, a polyvalent metal compound, and a polyvalent-metal salt of a carboxylic acid as a reaction product of a polycarboxylic acid-based polymer and a polyvalent metal compound.
